(19) United States
(12) Patent Application Publication
(10) Pub. No.: US 2015/0199340 A1
(43) Pub. Date: Jul. 16, 2015

(54) SYSTEM FOR TRANSLATING A LANGUAGE BASED ON USER'S REACTION AND METHOD THEREOF

(71) Applicant: Electronics and Telecommunications Research Institute, Daejeon (KR)

(72) Inventors: Oh Woog KWON, Daejeon (KR); Young Kil KIM, Daejeon (KR); Chang Hyun KIM, Daejeon (KR); Seung Hoon NA, Daejeon (KR); Yoon Hyung ROH, Daejeon (KR); Ki Young LEE, Daejeon (KR); Sang Keun JUNG, Daejeon (KR); Sung Kwon CHOI, Daejeon (KR); Yun JIN, Daejeon (KR); Eun Jin PARK, Daejeon (KR); Jong Hun SHIN, Daejeon (KR); Jin Xia HUANG, Daejeon (KR); Kang Il KIM, Daejeon (KR); Young Ae SEO, Daejeon (KR); Sang Kyu PARK, Daejeon (KR)

(73) Assignee: Electronics and Telecommunications Research Institute, Daejeon (KR)

(21) Appl. No.: 14/594,707

(22) Filed: Jan. 12, 2015

(30) Foreign Application Priority Data
Jan. 13, 2014 (KR) 10-2014-0003784

(51) Int. Cl. G06F 17/28; G10L 15/00

(52) U.S. Cl. CPC G06F 17/289; G10L 15/00

(57) ABSTRACT

The present invention relates to a system for translating a language based on a user's reaction, the system includes an interface unit which inputs uttered sentences of the first user and the second user and outputs the translated result; a translating unit which translates the uttered sentences of the first user and the second user; a conversation intention recognizing unit which figures out a conversation intention of the second user from the reply of the second user for a translation result of the utterance of the first user; a translation result evaluating unit which evaluates the translation of the uttered sentence of the first user based on the conversation intention of the second user which is determined by the conversation intention recognizing unit; and a translation result evaluation storing unit which stores the translation result and an evaluation of the translation result.

### CROSS-REFERENCE TO RELATED APPLICATIONS

This application claims priority to and the benefit of Korean Patent Application No. 10-2014-0003784 filed in the Korean Intellectual Property Office on Jan. 13, 2014, the entire contents of which are incorporated herein by reference.

### TECHNICAL FIELD

The present invention relates to a system for translating a language based on a user's reaction and a method thereof, and more particularly, to a technique which figures out a conversation intention in response to a user's reaction in a real-time interactive translating system to interactively translate a language with high reliability.

### BACKGROUND ART

An automatic translating system is implemented by converting a voice of a speaker into a text through voice recognition, converting the text into a language to be translated through machine translation, and allowing the other party to communicate to hear the converted language through voice synthesis. Generally, the automatic translating system includes a voice recognizing unit, an automatic translating unit, and a voice synthesizing unit.

Due to rapid development of a voice recognition technique, a natural language processing technique, a voice synthesis technique, and a noise processing technique, the automatic translating function may be implemented as software. Specifically, the automatic translating function is installed in embedded equipment such as a general cellular phone, a navigation system, a DMB and utilized in a wide field such as a computer, a TV, and a web application so that importance thereof is increased.

Most automatic translating systems go through a standardized process of voice recognition, translation, and voice synthesis regardless of a speaker and then process a result, but may not correct a recognition error or a translation error or correct an error through a process which requests the user to correct the error by himself/herself.

However, when the user is requested to correct the error by himself/herself, lots of translation results which are not represented by the user may be omitted and research on the satisfaction for the translation result may not be conducted due to the inconvenience of the user so that there is a limitation on usage of a collected translation result in order to improve the performance of the translation.

The translation result is evaluated by a person who requests the translation in an existing translating/interpreting device so that if the user is not bilingual, the evaluation may not be conducted.

In recent years, due to the development of Internet or mobile environment, a large amount of contents which are used by many users are collected in a server but the large amount of stored translation results needs to be evaluated first in order to improve the performance of the translation.

### SUMMARY OF THE INVENTION

The present invention has been made in an effort to provide a system for translating a language based on a user's reaction and a method thereof which may interactively translate a language with high reliability by figuring out a conversation intention of the other party from a reply of the other party and evaluating a translation result.

An exemplary embodiment of the present invention provides system for translating a language based on a user's reaction which translates conversation between a first user and a second user who speak different languages and provides the translated result, the system comprising: an interface unit which inputs uttered sentences of the first user and the second user and outputs the translated result; a translating unit which translates the uttered sentences of the first user and the second user; a conversation intention recognizing unit which figures out a conversation intention of the second user from the reply of the second user for a translation result of the utterance of the first user; a translation result evaluating unit which evaluates the translation of the uttered sentence of the first user based on the conversation intention of the second user which is determined by the conversation intention recognizing unit; and a translation result evaluation storing unit which stores the translation result and an evaluation of the translation result.

The conversation intention recognizing unit determines whether a reply of the second user is a doubt expression type indicating that the translation result of the utterance of the first user is not understood or an adaptive type indicating that the translation result of the utterance of the first user is understood.

The translation result evaluating unit negatively evaluates the translation result in the case of the doubt expression type and positively evaluates the translation result in the case of the adaptive type.

The translating unit translates the utterance of the first user into a plurality of translated sentences and presents all the plurality of translated sentences to the second user in the descending order of reliability.

The translation result evaluating unit automatically stores the evaluation the evaluation of the translated sentence which is understandable among the plurality of translated sentences as a positive evaluation and automatically stores the other translated sentences as a negative evaluation in the translation result evaluation storing unit.

When the conversation intention recognizing unit recognizes the conversation intention of the second user for the plurality of translated sentences as the doubt expression type, the translating unit outputs a sentence to induce the first user to input another sentence having a same meaning as the utterance

The translating unit translates the utterance of the first user into a plurality of translated sentences and present a translated sentence having the highest reliability among the plurality of translated sentences to the second user.

When the translated sentence having the highest reliability is presented to the second user, if the conversation intention of the second user is a doubt expression type by the conversation intention recognizing unit, the translating unit presents a translated sentence having a next highest reliability among the plurality of translated sentences to the second user.

The system may further include a voice recognizing unit which converts an input voice into a text when a voice of the uttered sentence is input from the first user or the second user.

The system may further include a voice synthesizing unit which converts the text which is translated by the translating unit into a voice.

The system may further include a translation knowledge storing unit which stores translation knowledge information is needed to translate in the translating unit; and a self learning unit which raises the reliability of a translation knowledge information or newly save the translation knowledge information used to generate a translation result having a positive evaluation and decreases the reliability of a translation knowledge information used to generate a translation result having a negative evaluation.

Another exemplary embodiment of the present invention provides a method for translating a language based on a user's reaction which translates conversation between a first user who speaks a first language and a second user who speaks a second language and provides the translated result, the method comprising: receiving an uttered sentence of the first language from the first user; translating the uttered sentence of the first language into the second language; presenting the translated sentence which is translated into the second language to the second user; receiving a reply to the translated sentence from the second user; evaluating the translated sentence by figuring out a conversation intention of the second user from the reply of the second user; and storing the translated sentence and the evaluation.

The method may further include updating translation knowledge information for the translation using the translation and the evaluation of the translation.

The receiving of an uttered sentence of the first language includes, when the uttered sentence is input as a voice, converting the uttered sentence into a text.

The evaluating of the translated sentence includes determining whether a reply of the second user is a doubt expression type indicating that the translation result of the utterance of the first user is not understood or an adaptive type indicating that the translation result of the utterance of the first user is understood.

The presenting of the translated sentence which is translated into the second language includes presenting a plurality of translated sentences which are translated into the second language.

The evaluating of the translated sentence includes induce the first user to input another sentence when the reply of the second user is the doubt expression type.

The presenting of the translated sentence which is translated into the second language includes presenting a translated sentence having the highest reliability among the translated sentences which are translated into the second language to the second user.

The evaluating of the translated sentence includes presenting a translated sentence having a next highest reliability among the translations which are translated into the second language to the second user when the reply of the second user is the doubt expression type.

The storing of the translated sentence and the evaluation includes storing the uttered sentence of the first user, a translated sentence of the uttered sentence of the first user, and an evaluation of the translated sentence of the uttered sentence of the first user.

According to the present technique, it is determined whether with respect to the translation result of the translating device, the translation is translated well in accordance with the other user's reaction to store the information and another translation is provided in accordance with the reaction of the other user to smoothly perform conversation between users which are bilingual.

Evaluation information about the translation is reflected to the translation knowledge so that reliability of a translation knowledge which presents a bad translation result is lowered and a translation knowledge which presents a good translation result is newly added or reliability thereof is increased to secure a larger amount of good quality translation knowledge, thereby automatically improving the reliability of the translation result.

### BRIEF DESCRIPTION OF THE DRAWINGS

FIG. 1 is a configuration diagram of a system for translating a language based on a user's reaction according to an exemplary embodiment of the present invention.

FIG. 2 is a flowchart illustrating a method for translating a language based on a user's reaction according to a first exemplary embodiment of the present invention.

FIG. 3 is an exemplary diagram of a conversation illustrating the first exemplary embodiment of the present invention.

FIG. 4 is a flowchart illustrating a method for translating a language based on a user's reaction according to a second exemplary embodiment of the present invention

FIG. 5 is an exemplary diagram of a conversation illustrating the second exemplary embodiment of the present invention.

FIG. 6 is an exemplary diagram of a conversation when a reaction of a second user is different in the second exemplary embodiment of the present invention.

### DETAILED DESCRIPTION

Hereinafter, the most preferred exemplary embodiments of the present invention will be described in detail with reference to the accompanying drawings so that those skilled in the art may easily carry out the technical spirit of the present invention.

The present invention is a technique which records and evaluates a translating process and a final result in a situation where at least two persons talk to each other using different languages to reflect the recorded and evaluated translating process and final result in an automatic translating and interpreting device, thereby improving a quality of translation.

That is, the present invention is a technique which presents an automatically translated sentence for a sentence of a user who requests the translation to the other party and the present invention figures out a conversation intention (expression of doubt or agreement) of the other party from a reply of the other party. The present invention automatically evaluates whether the translation result is translated well using the conversation intention of the other party and stores the evaluation result.

The present invention is a technique through which a part which is not translated well and a part which is translated well are learned by itself using the evaluation result of the translation result to update translating knowledge to improve a quality and present new automatic translation result in accordance with the response of the other user or present a part which is not understood by the other party to a person who requests the translation, thereby allowing two people which speak different languages to smoothly and easily talk to each other.

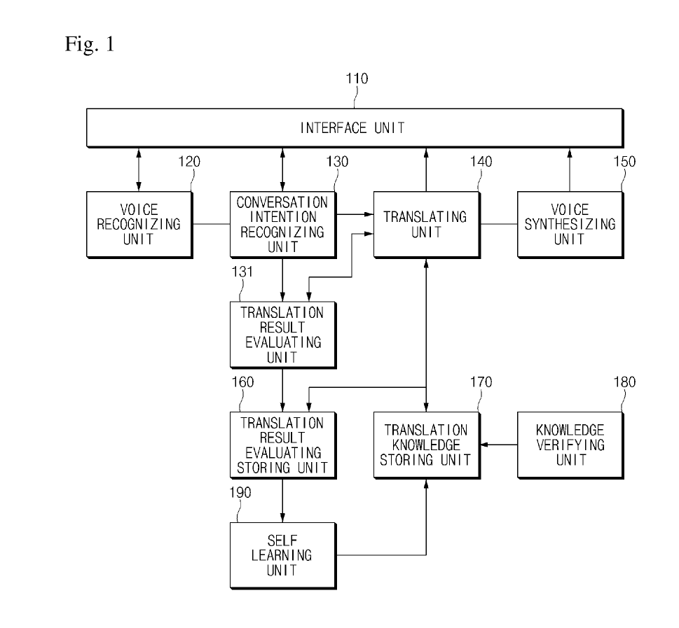

Hereinafter, a system for translating a language based on a user's reaction according to an exemplary embodiment of the present invention will be described with reference to FIGS. 1 to 6.

FIG. 1 is a configuration diagram of a system for translating a language based on a user's reaction according to an exemplary embodiment of the present invention.

A system for translating a language based on a user's reaction according to an exemplary embodiment of the present invention is a system which translates a conversation between speakers (a first user and a second user) and provides the translation and figures out a conversation intention of the second user from a reply of the second user (the other party) to the translation result of uttered sentence of the first user (speaker) to evaluate whether the translation result is good.

To this end, the system for translating a language based on a user's reaction according to an exemplary embodiment of the present invention includes an interface unit 110, a voice recognizing unit 120, a conversation intention recognizing unit 130, a translation result evaluating unit 131, a translating unit 140, a voice synthesizing unit 150, a translation result evaluation storing unit 160, a translation knowledge storing unit 170, a knowledge verifying unit 180, and a self learning unit 190. The interface unit 110 receives a voice or a text sentence of the speaker or inputs/outputs a translation result of utterance of the first user and a reply of the second user as a text or a voice. When a voice is input from the speaker, the interface unit 110 transmits the voice to the voice recognizing unit 120 and when a text is input from the speaker, the interface unit 110 transmits the text to the translating unit 140. Further, the interface unit 110 may output the translation result from the translating unit 140 and the voice from the voice synthesizing unit 150.

The voice recognizing unit 120 recognizes a voice in accordance with a target language using the voice transmitted from the interface unit 110 and information on a language of the voice and converts the input voice into a text sentence and then transmits the text sentence to the interface unit 110. In this case, the text which is converted by the voice recognizing unit 120 may be directly transmitted to the conversation intention recognizing unit 130 or the translating unit 140 without going through the interface unit 110.

The conversation intention recognizing unit 130 receives the text sentence which is input from the interface unit 110 or the text sentence which is converted by the voice recognizing unit 120 to determine conversation intention of the sentence. The conversation intention of the user may be classified into various types. In the present invention, it is determined whether the conversation intention is an adaptive conversation intention which may be generally replied in order to deal with the conversation intention of the first user or a conversation intention in order to express complaint or a doubt about the translation result. In this case, the conversation intention recognizing unit 130 of the present invention uses speech acts and conversation intention (dialog acts) which are described in an existing dialogue processing technology and additionally analyzes an intention requested by the user in response to the translation result such as the complaint about the translation result, presentation of a problem, and request of new translation result specifically using the speech acts and the dialog acts.

The translation result evaluating unit 131 evaluates the translation result of an uttered sentence of the first user in accordance with the conversation intention of the second user which is determined in the conversation intention recognizing unit 130. For example, when the conversation intention recognizing unit 130 determines that the conversation intention is to express a doubt because the second user cannot understand the translation result of the uttered sentence of the first user, the translation result evaluating unit 131 evaluates a translation status of the presented translation result to be negative (for example, “bad”) and controls the translation result evaluation storing unit 160 to store the evaluation result. In contrast, when the conversation intention recognizing unit 130 determines that the conversation intention is a conversation intention indicating that the second user is adaptive to the translation result of the uttered sentence of the first user, the translation result evaluating unit 131 evaluates a translation status of the presented translation result to be positive (for example, “good”) and controls the translation result evaluation storing unit 160 to store the evaluation result.

The translating unit 140 interworks with the translation knowledge storing unit 170 to automatically translate the text sentence which is input from the interface unit 110 and the voice recognizing unit 120 into a language of the other party (second user). Further, when the translation result evaluating unit 130 determines that the evaluation of the translation result is negative, the translating unit 140 checks whether there is a plurality of translation results for the sentence spoken by the first user. If there is a plurality of translation results, the translating unit 140 outputs a translation result having highest reliability next to the first presented translated sentence through the interface unit 110. In the meantime, if there is no other translation result for the sentence spoken by the first user, the translating unit 140 outputs a sentence which induces the first user to input other terms having the same meaning as the sentence spoken by the first user again through the interface unit 110. In this case, the sentence which induces the first user to input other terms having the same meaning as the sentence spoken by the first user may be extracted from the translation knowledge storing unit 170.

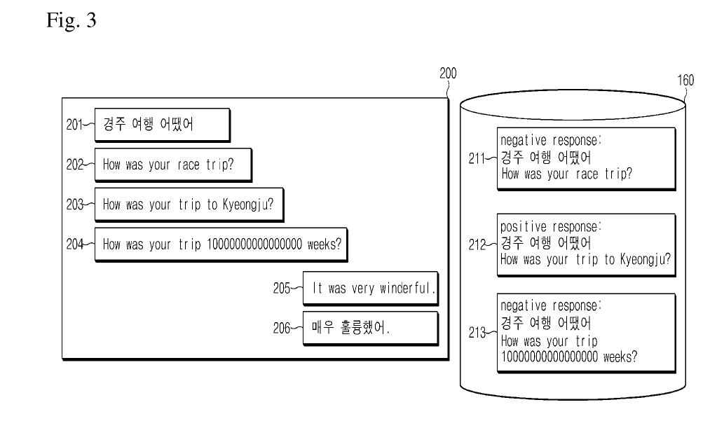

The voice synthesizing unit 150 provides the translation result received from the interface unit 110 and the corresponding result to the user as a voice and converts the text input from the interface unit 110 into the voice. To this end, the voice synthesizing unit 150 receives the text sentence and the target language, then converts the text sentence to a voice. The translation result evaluation storing unit 160 stores an uttered sentence which is input by the first user, a translated sentence of the uttered sentence, and an evaluation of the translated sentence. As illustrated in FIGS. 3, 5, and 6, the evaluation is stored to be classified into a positive evaluation (positive response) and a negative evaluation (negative response).

The translation knowledge storing unit 170 is a database DB in which a translation knowledge used to translate a language into another language in the translating unit 140 is stored. The translation knowledge includes linguistic or statistical knowledge for morphological analysis, part-of-speech aging, syntactic analysis, word and syntactic transfer, language generation, language model, etc. Further, the translation knowledge storing unit 170 may update the translation knowledge by the self learning unit 190 and the knowledge verifying unit 180.

The knowledge verifying unit 180 correct the translation knowledge storing unit 170 by a translation knowledge expert using a bad evaluation result, which is different from automatic improvement by self learning. That is, the knowledge verifying unit 180 supports the translation knowledge expert to correct, delete, and add translation knowledge of the translation knowledge storing unit 170 which is erroneous or omitted, using a large amount of bilingual translation information which is stored in the translation result evaluation storing unit 160. Further, the knowledge verifying unit 180 classifies sentences or sentence structures which frequently occur among the large amount of information stored in the translation result evaluation storing unit 160 into groups and provides the groups to the expert to support the expert to correct and add the translation knowledge which is significantly erroneous in the current device by priorly.

The self learning unit 190 uses the translation result evaluation storing unit 160 to change and adjust the learning result and the translation knowledge of the translation knowledge storing unit 170 in accordance with the information on parts which are translated well and translated bad in the translating unit 140. That is, the self learning unit 190 corrects, deletes, and adds the translation knowledge of the translation knowledge storing unit 170 to improve a translating performance of the translating unit 140 using the large amount of bilingual translation information (sentences requested by users to be translated and a translation results thereof, and evaluations of the other user) which is stored in the translation result evaluation storing unit 160.

To this end, the self learning unit 190 extracts the translation knowledge which translates an input sentence into a translated sentence well. Thereafter, when the translated sentence has a good evaluation, the extracted translation knowledge is added into the translation knowledge storing unit 170 with good reliability. If the extracted translation knowledge is a new knowledge which is not stored in the translation knowledge storing unit 170, the translation knowledge is added so as to have up to date reliability. If the extracted translation knowledge is a knowledge which is stored in the translation knowledge storing unit 170, the reliability of the knowledge is increased.

In the meantime, if the evaluation on the translated sentence is bad, the reliability of the translation knowledge in the translation knowledge storing unit 170 is lowered. If the translation knowledge having bad reliability extracted from the self learning unit 190 is not in the translation knowledge storing unit 170, the translation knowledge is initially stored in the translation knowledge storing unit 170 as a bad translation knowledge so that even when the translation knowledge is added as a good translation knowledge later, the translation knowledge may be used to lower the reliability.

Among the translation knowledge of the translation knowledge storing unit 170 which is self-developed by the self learning unit 190, a translation knowledge whose reliability is lower than a reference value is not used in the translating unit 140. As described above, the self learning unit 190 adds or updates the translation knowledge of the translation knowledge storing unit 170 using data of the translation result evaluation storing unit 160 which stores the translation results and the evaluations which are selected by the users so that the translating unit 140 improves the translation result using better translation knowledge.

Therefore, the present invention translates a language based on a user's reaction such that a sentence of a first user who requests the translation is automatically translated, the translated result is provided to a second user. The present invention figures out the intention of the second user from a reply of the second user for the translated result. The present invention evaluate automatically whether the current translation result is good translation or bad translation using the intention of the second user. Further, the present invention may improve the translation quality to self-study a part which is translated bad and a part which is translated well using an evaluation result and the translation result.

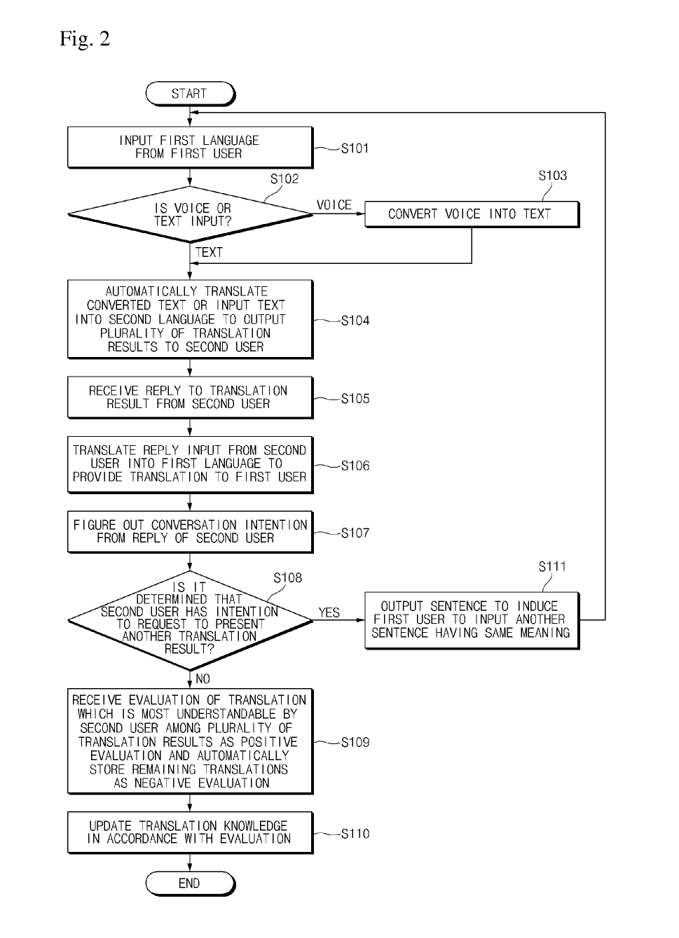

Hereinafter, a method for translating a language based on a user's reaction according to a first exemplary embodiment of the present invention will be described in detail with reference to FIGS. 2 and 3. The present embodiment will be described with an assumption that a user (first user) speaks Korean (a first language) and a user (second user) speaks English (a second language).

First, referring to FIG. 2, when a first language is input from a user through an interface unit 110 in step S101, the interface unit 110 distinguishes whether a voice is input or a text is input in step S102. When the input sentence is a voice, the interface unit 110 transmits the voice to the voice recognizing unit 120. The voice recognizing unit 120 converts the voice into a text in step S103.

Next, a translating unit 140 receives the text which is converted in the voice recognizing unit 120 or the text which is input from the interface unit 110 to automatically translate the text into the second language of the second user and output a plurality of translation results to the second user through the interface unit 110 in the descending order of reliability in step S104.

Next, a reply to the translation result is input from the second user through the interface unit 110 in step S105. That is, if the plurality of translation results includes an appropriate sentence, the second user replies to the appropriate sentence. Next, the translating unit 140 translates the reply to the translation result which is input through the interface unit 110 into the first language and provides the translated reply to the translation result to the first user in step S106.

Next, the conversation intention recognizing unit 130 figures out a conversation intention of the second user from the reply of the second user which is received from the translating unit in step S107. That is, the conversation intention recognizing unit 130 figures out whether the reply of the second user has a conversation intention to express a doubt or an adaptive conversation intention to adaptively reply to.

That is, the conversation intention recognizing unit 130 determines whether the second user has an intention to express a doubt to request to provide another translation result in step S108. If the conversation intention recognizing unit 130 determines that the second user has an adaptive intention, the translation result evaluating unit 131 receives an evaluation on the most appropriate sentence among the plurality of translation results from the second user and stores the evaluation in the translation result evaluation storing unit 160 in step S109. In this case, when the most appropriate sentence is stored with a positive evaluation, an inappropriate translation is also automatically stored with a negative evaluation. Further, the conversation intention recognizing unit 130 may control the interface unit 110 to output an evaluation inducement sentence to the second user in order to induce the evaluation on the translation result.

Thereafter, the self learning unit 190 or the knowledge verifying unit 180 updates the translation knowledge of the translation knowledge storing unit 170 in accordance with the evaluation result of the translation knowledge evaluation storing unit 160 in step S110.

In contrast, if the conversation intention recognizing unit 130 determines that the second user has an intention to express a doubt to request to provide another translation result, the translating unit 140 may control to output a sentence which induces the first user to input another word and sentence having the same meaning as the utterance which is initially input through the interface unit 110 in step S111.

Referring to FIG. 3, the method for translating a language based on a user's reaction according to the first exemplary embodiment of the present invention will be described below using an example sentence.

For example, when the first user inputs a Korean input sentence 201 ( [symbol] [symbol] ) through the interface unit 100 as a voice or a text, the translating unit 104 outputs a plurality (three) of translation results 202, 203, and 204 through the interface unit 110. In this case, the second user speaks English so that the second user selects a understandable sentence 203 among the plurality of translation results 202, 203, and 204 to input a reply sentence 205 and provide a translated result sentence 206.

In this case, the second user is requested to provide an evaluation request sentence to the interface unit 110 or evaluate the translation result through another input unit, the second user inputs an evaluation result evaluating that a translated sentence (“How was your trip to Kyeongju?”) 203 is the most appropriate among the plurality of translated sentences 202, 203, and 204. Therefore, the translation result evaluating unit 131 controls the translation result evaluation storing unit 160 to store the evaluation result which is input from the interface unit 110. In this case, as illustrated in the translation result evaluation storing unit 160 of FIG. 3, the evaluation results 211, 212, and 213 include evaluation contents (negative response or positive response), an input sentence ( [symbol] ) which is initially input by the first user, and the translation result.

It may be understood from FIG. 3 that the evaluation results 211 and 213 which are stored in the translation result evaluation storing unit 160 are stored as negative evaluations (negative responses) and the evaluation result 212 on the translated sentence 203 which is understandable to the second user is stored as a positive evaluation (positive response).

Therefore, when the input sentence 201 or a similar sentence is input later, the translating unit 140 does not output the translated sentences 202 and 204 with the negative evaluation but outputs only the translated sentence 203 with the positive evaluation. Further, a fatal translation error in the translated sentence 204 which translates Korean “ [symbol] ” into English “10000000000000000 weeks” is provided to the translation knowledge expert by the knowledge verifying unit 180 so that the fatal error may be immediately corrected.

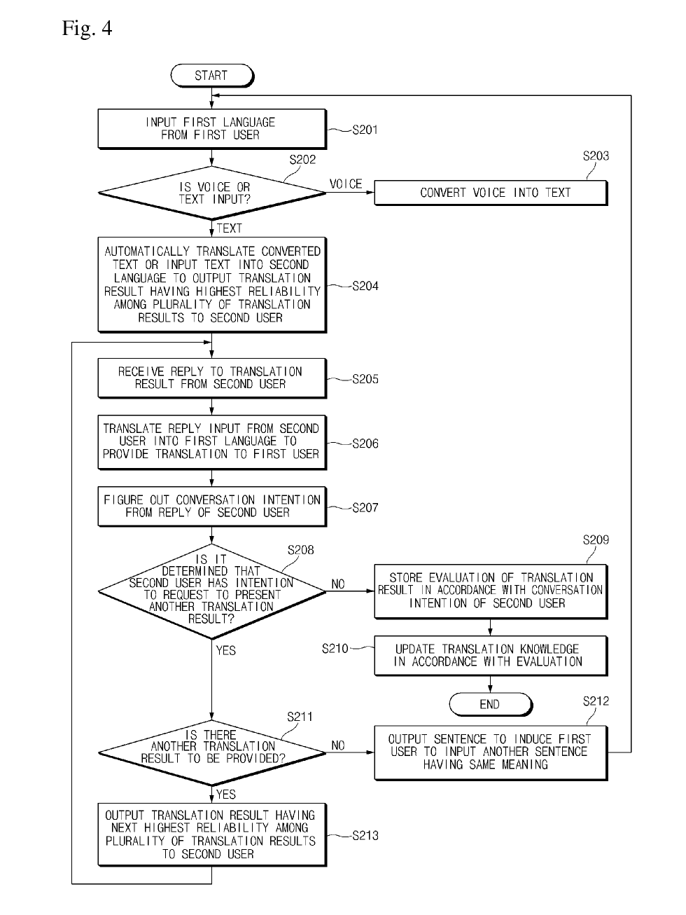

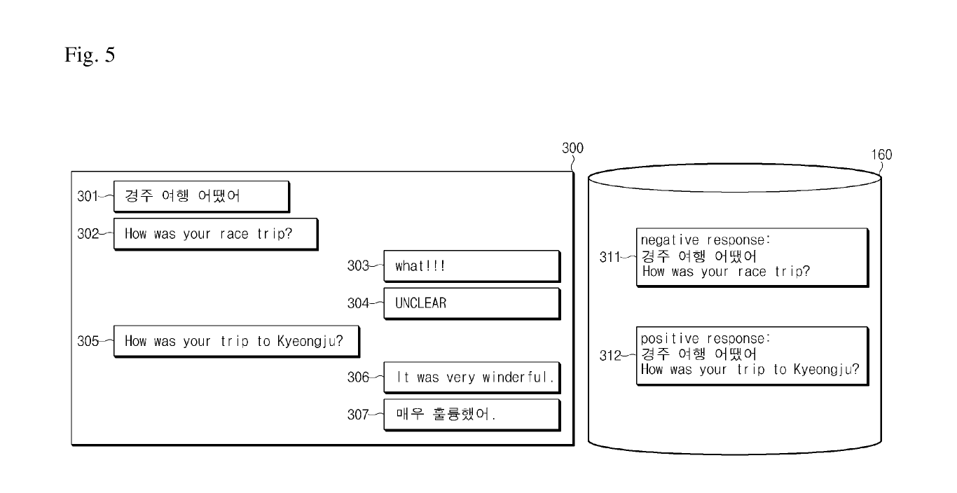

Hereinafter, a method for translating a language based on a user's reaction according to a second exemplary embodiment of the present invention will be described in detail with reference to FIGS. 4 and 5. The present embodiment will be described with an assumption that a user (first user) speaks Korean (a first language) and a user (second user) speaks English (a second language).

First, referring to FIG. 2, when a first language is input from a user through an interface unit 110 in step S201, the interface unit 110 distinguishes whether a voice is input or a text is input in step S202. When the input sentence is a voice, the interface unit 110 transmits the voice to the voice recognizing unit 120. The voice recognizing unit 120 converts the voice into a text in step S203.

Next, a translating unit 140 receives the text which is converted in the voice recognizing unit 120 or the text which is input from the interface unit 110 and automatically translates the text into the second language of the second user by interworking with the translation knowledge storing unit 170. Next, the translating unit 140 interworks with the translation result evaluation storing unit 160 to output a translation result having the high reliability more than a threshold (with the most positive evaluation) among a plurality of translation results to the second user through the interface unit 110 in step S204.

Next, a reply to the translation result is input from the second user through the interface unit 110 in step S205. That is, the second user checks the output translation result and inputs a reply thereto. Therefore, the translating unit 140 translates the reply of the second user into the first language of the first user through the interface unit 110 in step S206.

Next, the conversation intention recognizing unit 130 figures out a conversation intention of the second user from the reply of the second user which is received from the translating unit 140 in step S207. That is, the conversation intention recognizing unit 130 figures out whether the reply of the second user has an intention to express a doubt or an intention to adaptively reply to.

As described above, the conversation intention recognizing unit 130 determines whether the second user has an intention to express a doubt to request to provide another translation result in step S208. If the conversation intention recognizing unit 130 determines that the second user has the adaptive intention, the translation result evaluating unit 131 stores the evaluation result for the translation result as a positive evaluation in step S209. Next, the self learning unit 190 or the knowledge verifying unit 180 updates the translation knowledge of the translation knowledge storing unit 170 in accordance with the translation result of the translation knowledge evaluation storing unit 160 in step S210.

In contrast, if the conversation intention recognizing unit 130 determines that the second user has an intention to express a doubt to request to provide another translation result, the translating unit 140 determines whether there is another translation result which will be provided as a translation result for the input sentence in the translation result evaluation storing unit 160 in step S211.

If there is no other translation result to be provided, the translating unit 140 controls to output a sentence to induce the first user to input another sentence having the same meaning as the input sentence through the interface unit 110 in step S212. In the meantime, if there is another translation result to be provided, the translating unit 140 outputs a translation result having a next higher reliability among the plurality of translation results which is stored in the translation result evaluation storing unit 160 to the second user in step S213.

Next, the steps S205 to S213 are repeated again. However, in step S209, all the plurality of input sentences is stored and all the evaluations for the plurality of input sentences are stored. In other words, when a response having an intention to express a doubt for the first input sentence is received from the second user and a response having an adaptive intention for the second input sentence is input from the second user, the first input sentence is stored together with a negative evaluations and the second input sentence is stored together with a positive evaluation.

The method for translating a language based on a user's reaction according to the second exemplary embodiment of the present invention will be described below using an example sentence with reference to FIG. 5.

First, when the first user inputs an input sentence 301 ( [symbol] ) in Korean through the interface unit 110, the translating unit 140 outputs a translated sentence 302 having the highest reliability from translation result evaluation information which is stored in the translation result evaluation storing unit 160. In this case, the second user checks the translated sentence 302, replies using an English expression 303 (ex, what!) saying that the output English translated sentence 302 does not make sense. Therefore, the conversation intention recognizing unit 130 recognizes an intention that complains or dissatisfies the translation result and outputs a translated sentence 305 having a next highest reliability to the first output translated sentence 302 among the results translated in the translating unit 103 with respect to the input sentence 301 of the first user through the interface unit 110. When the second user understood the translation in the conversation situation to input a replying sentence 306, the conversation intention recognizing unit 130 recognizes a natural conversation intention with the other party and provides a translated sentence 307 for the reply through the translating unit 140 to the first user.

Next, during the above processes, the translated sentence 302 for which the second user expresses a doubt is stored in the translation result evaluation storing unit 160 as an evaluation result 311 with a negative evaluation and the translated sentence 305 which is understood by the second user is stored as an evaluation result 312 with the positive evaluation.

Next, the self learning unit 190 may update the translation knowledge of the translation knowledge storing unit 170 using the translation results stored in the translation result evaluation storing unit 160 later. Therefore, if the input sentence 301 or a similar sentence is input, the translated sentence 305 which is positively evaluated may be provided first, which is different from FIG. 5.

However, in the above example, if the translating unit 140 does not have a translation which is understood or satisfied by the second user for the input sentence 301 of the first user, the translating unit 140 may be induce the first user to input another sentence having the same meaning to proceed the conversation.

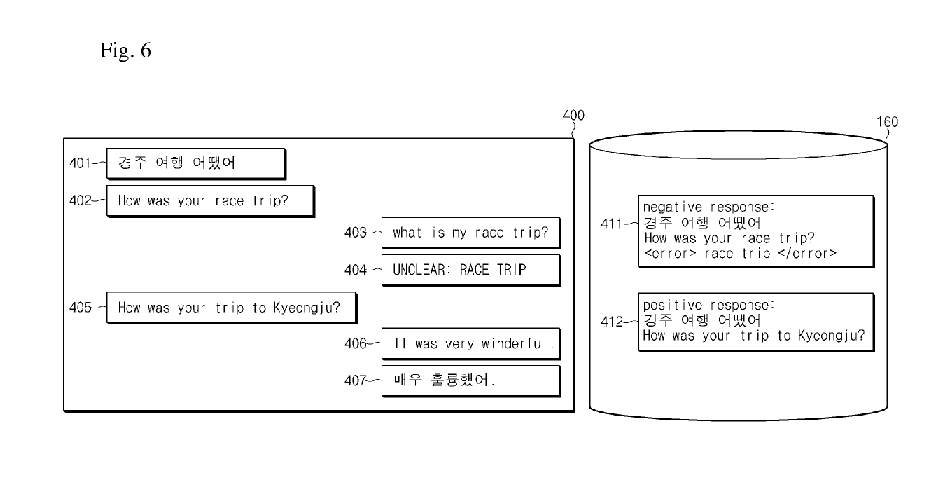

FIG. 6 is an exemplary diagram of a conversation when a reaction of a second user is different in the second exemplary embodiment of the present invention. When the first user inputs the input sentence 401 and a translating device provides the translated sentence 402 as illustrated in FIG. 6, if the second user inputs a sentence 403 saying that a specific word or sentence is not understood, the conversation intention recognizing unit 130 recognizes that the user expresses a complaint about a specific translated sentence “race trip” which does not make sense in the existing translated sentence 402.

Therefore, the translating unit 140 translates the part which is not understood by the second user into the language 404 of the first user and outputs the translation to the first user through the interface unit 110.
Further, the translation result evaluation storing unit 160 stores the evaluation result 411 together with a specific part “race trip” which is suggested by the second user as an error to be utilized by the self learning unit 190.
The evaluation result 411 having error information is shared to the first user, the translating unit 140 may conduct a conversation so as to avoid the expression which may cause an error in the translating device when the first user inputs the same meaning again. So the present invention efficiently communicates the conversation using a limited performance of the translating device.

FIGS. 2 to 6 of the present invention disclose as an example only a case in which the translating unit 140 provides a plurality of translated sentences but even when the translating unit 140 provides one translated sentence, the one translated sentence may be evaluated in accordance with the reply (response) of the other party (second user). Further, when the evaluation result is bad, a reliability of the knowledges of the translation knowledge storing unit 170 which is used to translate a language by the self learning unit 190 is lowered. In contrast, if the evaluation result is good, the reliability of the used translation knowledges is raised to improve the translation knowledges.

As described above, according to the present invention, the translating device determines whether the translation is good in accordance with the reaction of the other party (second user) for the translation result and stores a determination result to utilize as translation knowledge. Therefore, a reliability of the translation knowledge which presents a bad translation result is lowered and the translation knowledge which presents a good translation result is newly added or reliability thereof is raised so that a large amount of good quality translation knowledge is secured to automatically improve the translation result. Further, it is checked whether the input sentence of the other party is a complaint or dissatisfaction about the translation quality and operation corresponding to the complaint/dissatisfaction is performed to the user to efficiently conduct the conversation.

While the exemplary embodiments of the present invention have been described for illustrative purposes, it should be understood by those skilled in the art that various changes, modifications, substitutions, and additions may be made without departing from the spirit and scope of the present invention as defined in the appended claims.

What is claimed is:

1. A system for translating a language based on a user's reaction which translates conversation between a first user and a second user who speak different languages and provides the translated result, the system comprising:
an interface unit which inputs uttered sentences of the first user and the second user and outputs the translated result;
a translating unit which translates the uttered sentences of the first user and the second user;
a conversation intention recognizing unit which figures out a conversation intention of the second user from the reply of the second user for a translation result of the utterance of the first user;
a translation result evaluating unit which evaluates the translation of the uttered sentence of the first user based on the conversation intention of the second user which is determined by the conversation intention recognizing unit; and
a translation result evaluation storing unit which stores the translation result and an evaluation of the translation result.

2. The system of claim 1, wherein the conversation intention recognizing unit determines whether a reply of the second user is a doubt expression type indicating that the translation result of the utterance of the first user is not understood or an adaptive type indicating that the translation result of the utterance of the first user is understood.

3. The system of claim 2, wherein the translation result evaluating unit negatively evaluates the translation result in the case of the doubt expression type and positively evaluates the translation result in the case of the adaptive type.

4. The system of claim 2, wherein the translating unit translates the utterance of the first user into a plurality of translated sentences and presents all the plurality of translated sentences to the second user in the descending order of reliability.

5. The system of claim 4, wherein the translation result evaluating unit automatically stores the evaluation the evaluation of the translated sentence which is understandable among the plurality of translated sentences as a positive evaluation and automatically stores the other translated sentences as a negative evaluation in the translation result evaluation storing unit.

6. The system of claim 4, wherein when the conversation intention recognizing unit recognizes the conversation intention of the second user for the plurality of translated sentences as the doubt expression type, the translating unit outputs a sentence to induce the first user to input another sentence having a same meaning as the utterance

7. The system of claim 1, wherein the translating unit translates the utterance of the first user into a plurality of translated sentences and present a translated sentence having the highest reliability among the plurality of translated sentences to the second user.

8. The system of claim 7, wherein when the translated sentence having the highest reliability is presented to the second user, if the conversation intention of the second user is a doubt expression type by the conversation intention recognizing unit, the translating unit presents a translated sentence having a next highest reliability among the plurality of translated sentences to the second user.

9. The system of claim 1, further comprising:
a voice recognizing unit which converts an input voice into a text when a voice of the uttered sentence is input from the first user or the second user.

10. The system of claim 1, further comprising:
a voice synthesizing unit which converts the text which is translated by the translating unit into a voice.

11. The system of claim 1, further comprising:
a translation knowledge storing unit which stores translation knowledge information is needed to translate in the translating unit; and
a self learning unit which raises the reliability of a translation knowledge information or newly save the translation knowledge information used to generate a translation result having a positive evaluation and decreases the reliability of a translation knowledge information used to generate a translation result having a negative evaluation.

12. A method for translating a language based on a user's reaction which translates conversation between a first user who speaks a first language and a second user who speaks a second language and provides the translated result, the method comprising:
receiving an uttered sentence of the first language from the first user;
translating the uttered sentence of the first language into the second language;
presenting the translated sentence which is translated into the second language to the second user;
receiving a reply to the translated sentence from the second user;
evaluating the translated sentence by figuring out a conversation intention of the second user from the reply of the second user; and
storing the translated sentence and the evaluation.

13. The method of claim 12, further comprising:
updating translation knowledge information for the translation using the translation and the evaluation of the translation.

14. The method of claim 12, wherein the receiving of an uttered sentence of the first language includes, when the uttered sentence is input as a voice, converting the uttered sentence into a text.

15. The method of claim 12, wherein the evaluating of the translated sentence includes determining whether a reply of the second user is a doubt expression type indicating that the translation result of the utterance of the first user is not understood or an adaptive type indicating that the translation result of the utterance of the first user is understood.

16. The method of claim 15, wherein the presenting of the translated sentence which is translated into the second language includes presenting a plurality of translated sentences which are translated into the second language.

17. The method of claim 16, wherein the evaluating of the translated sentence includes induce the first user to input another sentence when the reply of the second user is the doubt expression type.

18. The method of claim 15, wherein the presenting of the translated sentence which is translated into the second language includes presenting a translated sentence having the highest reliability among the translated sentences which are translated into the second language to the second user.

19. The method of claim 18, wherein the evaluating of the translated sentence includes presenting a translated sentence having a next highest reliability among the translations which are translated into the second language to the second user when the reply of the second user is the doubt expression type.

20. The method of claim 12, wherein the storing of the translated sentence and the evaluation includes storing the uttered sentence of the first user, a translated sentence of the uttered sentence of the first user, and an evaluation of the translated sentence of the uttered sentence of the first user.
